(19) United States
(12) Patent Application Publication
(10) Pub. No.: US 2006/0095287 A1
(43) Pub. Date: May 4, 2006

(54) Interaction between service providers and customers

(75) Inventor: David Neil Slatter, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/258,352

(22) Filed: Oct. 26, 2005

(30) Foreign Application Priority Data
Oct. 29, 2004 (GB) 0424160.0

(51) Int. Cl. G06Q 99/00

(52) U.S. Cl. 705/1

(57) ABSTRACT

A document is described which has on it both printed information and a memory tag. The memory tag is a transponder device with a memory for storing digital content. The memory contains information relating to the progression of a transaction between a customer and a service provider.

### FIELD OF THE INVENTION

The invention relates to interaction between service providers and customers. More specifically, it relates to improvements in telephonic interaction between service providers and customers.

### BACKGROUND OF THE INVENTION

Service providers frequently use mail shots to communicate with potential customers inviting a telephone response. Such mail shots are of limited effectiveness, in part because the recipient may consider the interactions that will follow, typically with a customer representative in a call centre, as being of an unsatisfactory character. Interaction by mail, while it may be facilitated by the provision of forms in which the recipient's details have been entered (possibly inaccurately), will be slow and time to completion will be uncertain.

Mail shots however also have considerable advantages, as they deliver information to potential customers in a preferred, printed, form.

A problem to be addressed by service providers is how to make interactions with recipients of mail shots more effective. Solution to this problem may have one or more of the following benefits: increasing the likelihood of a response from the addressee; using the time of call centre customer representatives more effectively; and minimising the overall cost of interaction with customers or maximising the return for cost of a mail shot.

### SUMMARY OF THE INVENTION

In one aspect, the invention provides a document having printed information and a memory tag thereon, wherein the memory tag is a transponder device with a memory for storing digital content, the memory containing therein information relating to the progression of a transaction between a customer and a service provider.

### DESCRIPTION OF DRAWINGS

Specific embodiments of the invention will now be described, by way of example, with reference to the accompanying drawings, of which:

FIG. 1 shows a mail flyer according to an embodiment of the invention;

FIG. 2 shows schematically the elements of a memory tag suitable for use in embodiments of the invention;

FIG. 3 shows circuitry for the memory tag of FIG. 2 and for a suitable reader device;

FIG. 4 shows a design for a printer suitable for printing the mail flyer of FIG. 1 containing a memory tag as shown in FIGS. 2 and 3 according to an embodiment of the invention;

FIG. 5 shows the interacting elements in the use of a mail flyer as shown in FIG. 1 to facilitate an interaction between a customer and a service provider;

FIG. 6 illustrates the flow of actions according to an embodiment in which a memory tag holds call routing information for the customer;

FIG. 7 illustrates the flow of actions according to an embodiment in which a memory tag holds an identifier for the customer;

FIG. 8 illustrates the flow of actions according to a first embodiment in which a memory tag holds transaction information for the customer; and

FIG. 9 illustrates the flow of actions according to a second embodiment in which a memory tag holds transaction information for the customer; and

FIG. 10 illustrates the flow of actions according to an embodiment in which a memory tag holds an SMS order form for use by the customer.

### DESCRIPTION OF SPECIFIC EMBODIMENTS

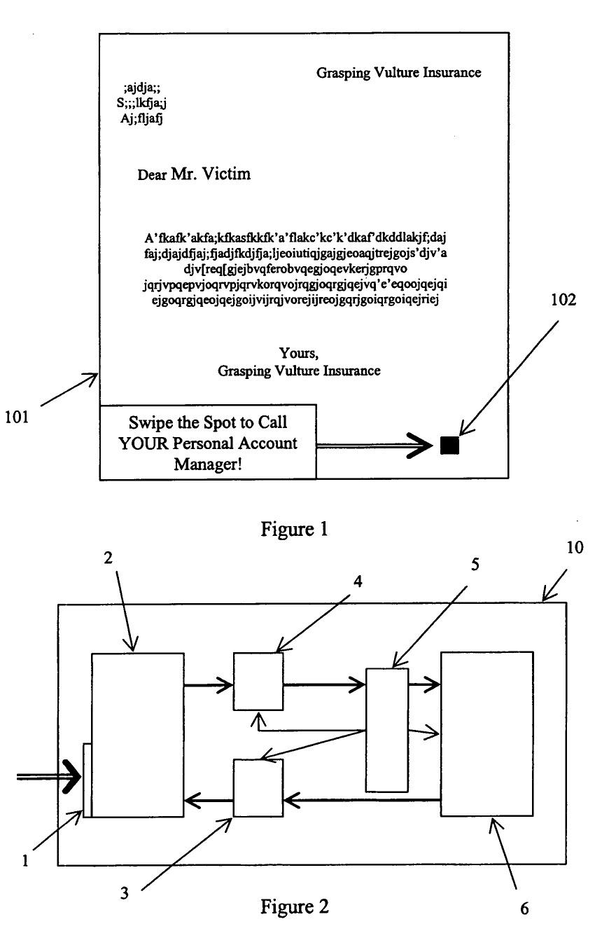

FIG. 1 shows a document according to embodiments of the invention. The document in this case is mail flyer 101, personally addressed to a recipient having been sent by a service provider. It has on it a memory tag 102 containing information related to progression of a transaction between the service provider and the recipient.

In many embodiments of the invention, the information in the memory tag will be personalised to the recipient, and in such cases the document will often most conveniently be provided as a mail flyer addressed to the recipient. In other embodiments, the information in the memory tag will be directed to the class of transaction rather than to a particular recipient. In such cases, while the document may be a mail flyer, it need not be addressed to a specific recipient at all. It may, for example, be provided in an information leaflet describing the class of transaction, in a promotional item, or in any other appropriate form.

A memory tag may be generally considered as a transponder device with significant memory—sufficient to store significant digital content rather than just identifier data—and an exemplary device of this kind is described below. The type of memory tag discussed here is designed to be read by a suitable reader device at close range and to provide rapid data transmission—data can thus be read by “brushing” the reader device across the memory tag.

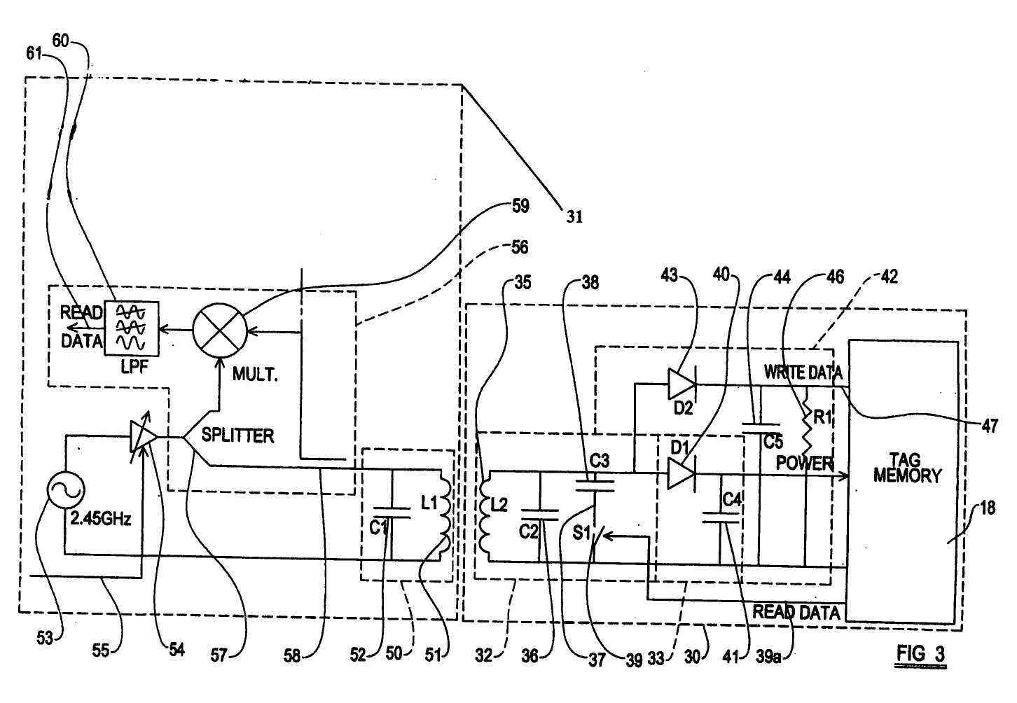

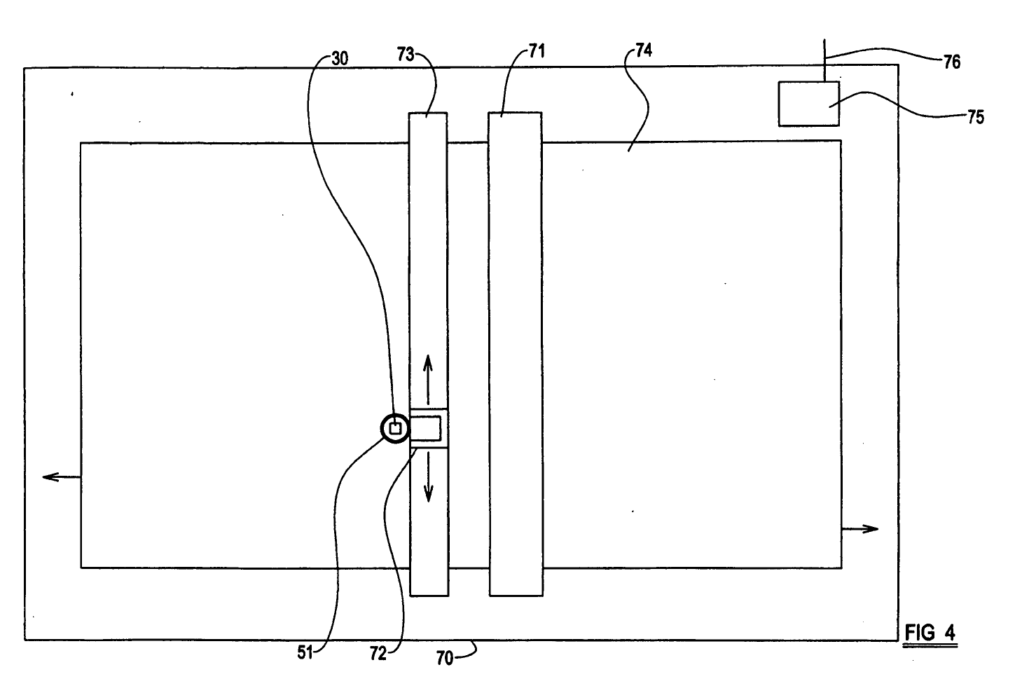

The schematics of a suitable memory tag will be described in FIG. 2. Circuitry for such a tag and for a suitable reader will be described in FIG. 3. A printer device suitable for printing the mail flyer of FIG. 1 bearing a memory tag of the form described with reference to FIGS. 1 and 2 will be shown in FIG. 4. The memory tag described below is adapted so that data can be not only read from it by the reader, but also so that data can be written to it. This is relevant to some, though not to all, embodiments of the invention.

The elements of an RFID-like memory tag 10 are shown in FIG. 2. Such a tag is inductively powered by an RF signal received from a reader, and is also read by and (in relevant embodiments) written to by such a reader (strictly, reader/writer) device. The memory tag contains an antenna 1 to receive signal from the reader device and transponder circuitry 2 to extract power from the received signal to power the memory tag and to receive data from a read data circuit 3 to allow data to be provided from the tag memory 6 by varying a resonant circuit of the transponder circuitry 2. A write data circuit 4 is provided to detect data to be written to the tag memory 6 and also for control data to be provided to the memory tag—detected data is provided to control logic 5. Control logic 5 is provided to control the operations of the memory tag in response to the signals received from the reader device.

Depending on the nature of the memory tag, Control logic 5 can vary very considerably in complexity. For a tag which, once manufactured, can only be read and not written to, control logic 5 need not exist—the tag may be adapted simply so that when it is powered up, it simply transmits its content from beginning to end repeatedly until it is no longer powered. Any greater level of complexity requires some logic—for example, a read-only tag may initially return only a first set of data, but would be responsive to a specific signal from the reader to return a second set of data instead (for example, from a list of choices provided in the first set of data). Similarly, a tag which can be both read and written to requires sufficient control logic such that the reader can prepare the tag to receive data for writing to the tag memory and to stop such writing (for example, by providing an “end of data” signal or by specifying the number of bits of data to be written in advance). Where more complex operation is required from the memory tag, control logic 5 may be a suitable processor.

FIG. 3 shows an exemplary memory tag 30, though without indicating control circuitry (which may for these purposes be considered as part of the tag memory block 18), together with a reader (or reader/writer) device 31. The tag 30 comprises a resonant circuit part 32 and a rectifying circuit part 33, together with a memory 18. The resonant circuit part 32 comprises an inductor L2 35 and a capacitor C2 36 connected in parallel

The resonant circuit part 32 further comprises a controllable capacitive element generally indicated at 37, in the example of FIG. 3 comprising a capacitor C3 38 and a switch S1 39 which is connected to a read data line 39a connected to the memory 36 to modulate the resonant frequency of the resonant circuit part 32. The rectifying part 33 comprises a diode D1 40 connected to the resonant circuit part 32 in a forward biased direction and a capacitor C4 41 connected in parallel with the components of the resonant circuit part 32. The rectifying circuit part 33 operates as a half-wave rectifier to provide power to the memory 18. The tag 30 further comprises a write data circuit part 42. The write data circuit part 42 comprises a diode D2 43 connected in the forward bias direction to the output of the resonant circuit part 32, with a capacitor C5 44 and a resistor R1 46 connected in parallel with the components of the resonant circuit part 32. The write data circuit part 42 in this case comprises a simple envelope detector which is responsive to the magnitude of the signal generated by the resonant circuit part 32, and provides a write data signal on a line 47 to the memory 18. For these purposes such “write data” may include control data, and control logic is considered as lying within the element denoted as memory 18.

The read/write device 31 in like manner to the memory tag comprises a resonant circuit part 50 which comprises an inductor L1 51 and a capacitor C1 54 connected in parallel. A frequency generator 53 is connected to the resonant circuit part 50. The read/write device 31 further comprises an amplitude modulator 54 which is controllable in response to data sent on a write data line 55. The amplitude modulator 54 controls the power of the signal from the frequency generator 53 to the resonant circuit part 50, and thus provides modulation of the amplitude of the power of the signal generated by the resonant circuit part 32 which can be detected by the write data circuit part 42 of the tag 30.

The read/write device 31 further comprises a demodulator, generally shown at 56. The demodulator 46 comprises a splitter 57 connected to the frequency generator 45 to split off a part of the signal to provide a reference signal. A coupler 58 is provided to split off a part of the reflected signal reflected back from the resonant circuit part 50. The reference signal and reflected signal are passed to a multiplier indicated at 59. The multiplier 59 multiplies the reflected signal and the reference signal and passes the output to a low pass filter 60. The low pass filter 60 passes a signal corresponding to the phase difference between the reference signal and the reflected signal to an output 61. By controlling the switch S1 39 of the tag 30 under control of the memory 34, the resonant frequency of resonant circuit part 32 can be modulated and hence the phase of the reflected signal reflected by the resonant circuit part 50 with respect to a reference signal can be modulated. This change of phase is detected by the demodulator 55, and so data can be read from the tag by the read/write device 31. By this method, data may be transmitted from the tag 30 whilst not significantly affecting the power drawn by the resonant circuit part 32.

A printer suitable for printing the document of FIG. 1 including the memory tag of FIGS. 2 and 3 is shown in FIG. 4. Printer 70 is provided with means to handle and print on a base medium—in this case, a roller shown diagrammatically at 71 and a print head 72 movable on a track 73. The printer 70 is operable to receive a suitable flexible base medium, in this example a sheet of paper 74, provided with a tag 30 adhered to or formed on the paper 74. In this example, the print head 72 is provided with a read/write device 31, and the inductor 51 comprises a loop antenna projecting from the print head 72. The printer comprises a printer controller 75 provided with an external connection 76, for example to a computer to receive data to be printed. The printer controller 75 is operable to control the rollers 71 to feed the paper sheet 74, and also to move the print head 72 along the track 73 and instruct the print head 72 to print on the paper 74.

In this embodiment, the printer controller 75 will be aware of the position of the paper sheet 74 by virtue of operation of the roller assembly 71 and also knows the position of the print head 72 on the track 73. The printer controller may also know the position of the memory tag 30 on the paper (if the paper is of a specified type) or may be able to discover its position—appropriate technology for this is discussed in the applicants' EP-A-1431903. Data to be written to the document can be provided by a computing device (not shown) to the printer controller 75—the print job may for example be accompanied by a transmission of data to be written to the memory tag associated with that print job. The skilled person will appreciate that this, and also the writing of multiple memory tags for a single print job, can be achieved by ordinary skill in the art.

Documents may of course also be produced by separately writing to and affixing the memory tag 30 before or after the printing of the document.

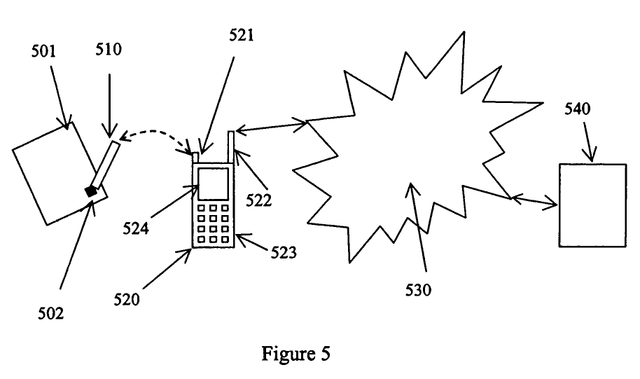

A series of examples will now follow, showing how a document such as that shown in FIG. 1 may be used, with different content or different functionality, or both, in the memory tag 102, to facilitate a transaction between a service provider and a customer (in most examples, the addressee of the document). Different arrangements are possible (as the skilled person will appreciate), but the physical elements involved in the examples as specifically described below are as indicated in FIG. 5. A document 501 has on it a memory tag 502. The memory tag is read (and in some examples, written to) by a reader device 510, here shown as communicating by a short-range wireless protocol (such as Bluetooth) with a cellular telephone 520 through its first antenna 521. The cellular telephone has a user interface 523 and a display 524, and a second antenna 522 for communication with the relevant cellular telephony infrastructure (designated 530). The service provider is represented by system 540—in some, but not all, examples discussed below, system 540 will comprise an automatic call distribution (ACD) system supported by customer relationship management (CRM) software, which in combination provide routing of calls to a suitable operator who is also provided with suitable information for that customer.

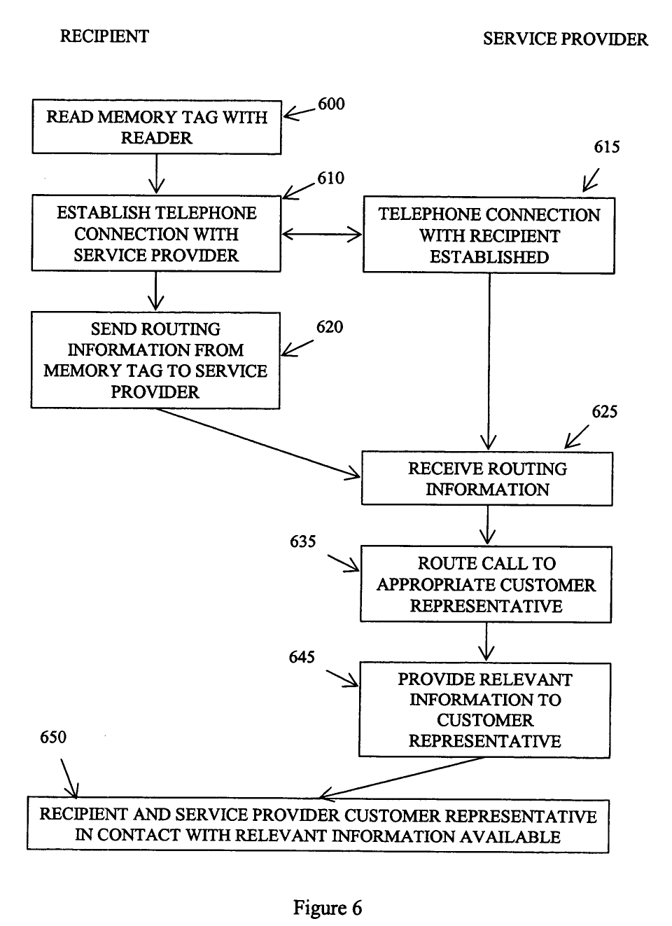

The first example is illustrated schematically in FIG. 6 (with reference to the physical elements of FIG. 5). In this example, the memory tag contains information which allows routing of a call from the recipient to an appropriately informed customer operative. This goes beyond the simple provision of a telephone number in a memory tag (U.S. Pat. No. 6,611,673 discusses the possibility of using RFID tags containing telephone numbers in a variety of contexts, including advertising and promotional material) and extends to enabling contact not simply with the service provider but with an appropriately informed customer representative of the service provider. To do this, the memory tag 502 contains information that allows appropriate routing through the ACD of the service provider for further discussion of the information provided in the document (this may be response to a specific offer, seeking further information about a specific service advertised by the service provider, or a request for enrolment in a specific program, for example). This may be achieved by providing a routing code to be provided once a telephone connection is established between the document recipient and the service provider. This may be provided in the form of a single number with a sufficient pause gap between initial number and routing code to be sure that a connection will be established, or may be provided as code for upload by the cellular telephone 520 such that when the code is executed the telephone is programmed to provide responses (this may be the desirable approach where a maximum response time cannot be guaranteed or where a routing through a series of choices is required and a single code would not be adequate). Steps taken by the recipient and by the service provider are shown in FIG. 6.

The recipient of the document, having decided that he or she wishes to contact the service provider to enter into or discuss an appropriate transaction, reads (600) the information in the memory tag using the reader. This provides the information stored by the memory tag to the cellular telephone. As discussed above, this may be in the form of a single number with a long enough space between service provider address and routing information to ensure that the connection is made before the routing information is provided, or may instead be in the form of code adapted not to provide routing information until prompts are received from the service provider. The recipient then calls the service provider (typically this will be done by using dialling information provided in the information listed in the memory tag, though in some embodiments the memory tag may contain only the routing information and not the initial dialling information) and establishes a telephone connection (610, 615) with the service provider. The recipient then provides the routing information (620). In one arrangement, this may be provided as one single code, but may also be provided as a routing through a hierarchical menu on response to prompts, in which case the routing information also provides means to recognise prompts (it may not be necessary to recognise menu choices, if the menu structure is not changed since the preparation of the document).

On receiving the routing information (625), the service provider system must interpret it. Where the routing information is provided as a single code, this code may be held by the service provider ACD with a reference to information which the customer representative will require in interacting with the recipient, together with in some embodiments an indication of which customer representatives (by class, for example those customer representatives representing a specific part of the service provider's operation, or possibly as individuals) can complete the call. The ACD then routes the call (635) to an appropriate customer representative and provides the customer representative (645) with information to enable the customer representative to interact effectively with the recipient (this may be, for example, a website related to a class of transaction advertised in the document). The recipient and customer representative can then interact (650) without the need for preliminary discussion of the recipient's reason for calling and without need to route the call to a different customer representative.

In this arrangement, the routing information may be relevant to the information stored in the document (ie to a particular service offered by the service provider) rather than to any individual. In this case, identical memory tags may be used for an entire run of direct mailings to different recipient addresses. These can be prepared en masse without need for an individual writing operation linked to the preparation of a document for a specific recipient, and can be provided before or after the printing of the document. This is a particularly inexpensive approach to improving the efficiency of communication between recipient and customer representative.

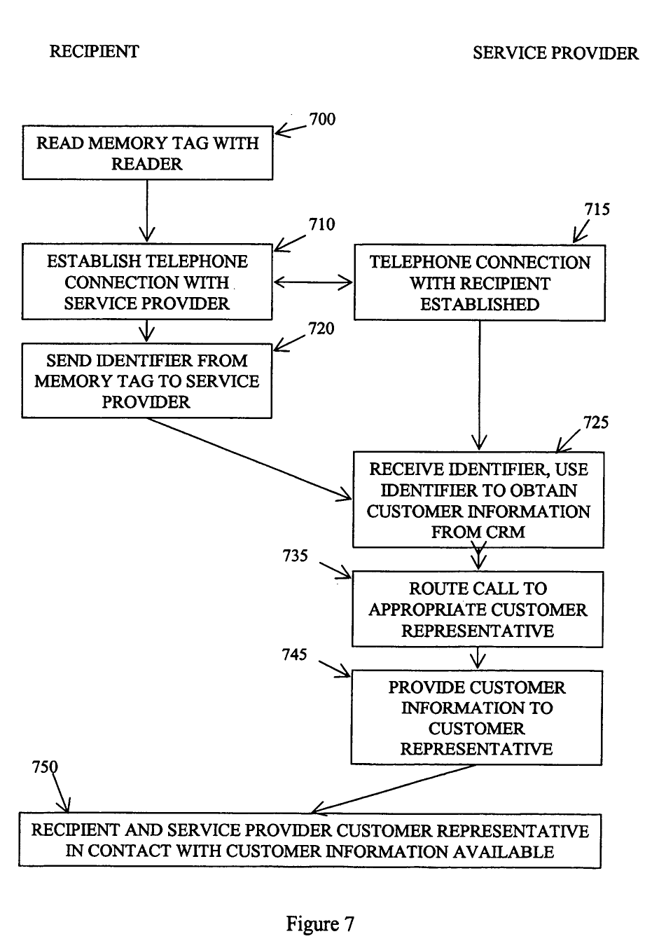

A different approach which may achieve greater efficiency at greater cost is discussed with relevance to FIG. 7. This case resembles that of FIG. 6 in that the memory tag holds routing information to enable communication with the service provider to be directed to an appropriately briefed customer representative, but differs in that this routing information is personalised to the recipient and serves as an identifier for the recipient. The identifier will be presented to the service provider system as before, but in this case the CRM as well as the ACD are used to ensure that the call is routed to a customer representative who has information related to the recipient as a customer. The identifier may simply identify the recipient, but may also identify the subject matter of the document to ensure that the customer representative has all necessary information available for interaction with the recipient.

The recipient of the document reads (700) the information in the memory tag using the reader. This provides the information stored by the memory tag to the cellular telephone. This may be in the form of a single number with a gap between calling information and identifier, as an identifier number alone (if the call is made separately) or as appropriate executable code. The recipient then calls the service provider (as before, generally using information provided on the memory tag) and establishes a telephone connection (710, 715) with the service provider. The recipient then provides the identifier (720).

On receiving the identifier (725), the service provider system accesses its CRM system to establish the identity of the recipient. The identifier may not merely identify the recipient, but may also indicate the information or service to which the document relates. The ACD the routes the call (735) to an appropriate customer representative—if the information revealed by the identifier determines that some customer representatives will be appropriate and some will not, then this may affect the routing decision. The customer representative is provided (745) with information relating to the recipient as a customer of the service provider, and may also be provided with information relating to the document (as in the example illustrated in FIG. 6). The recipient and customer representative are then able to interact (750) without need for exchanging any, or much, preliminary information—some security is provided by some level of assurance that the party claiming to be the recipient has had access to a letter addressed by recipient, but where this does not provide a sufficient level of security a further security interaction may take place at this point.

This approach does require the personalisation of each memory tag to the recipient, but it has the benefit of achieving very efficient interaction between recipient and customer representative with consequent benefit to both recipient (who can now interact with the service provider with minimal inconvenience) and service provider (who can minimise time spent per call in a call centre).

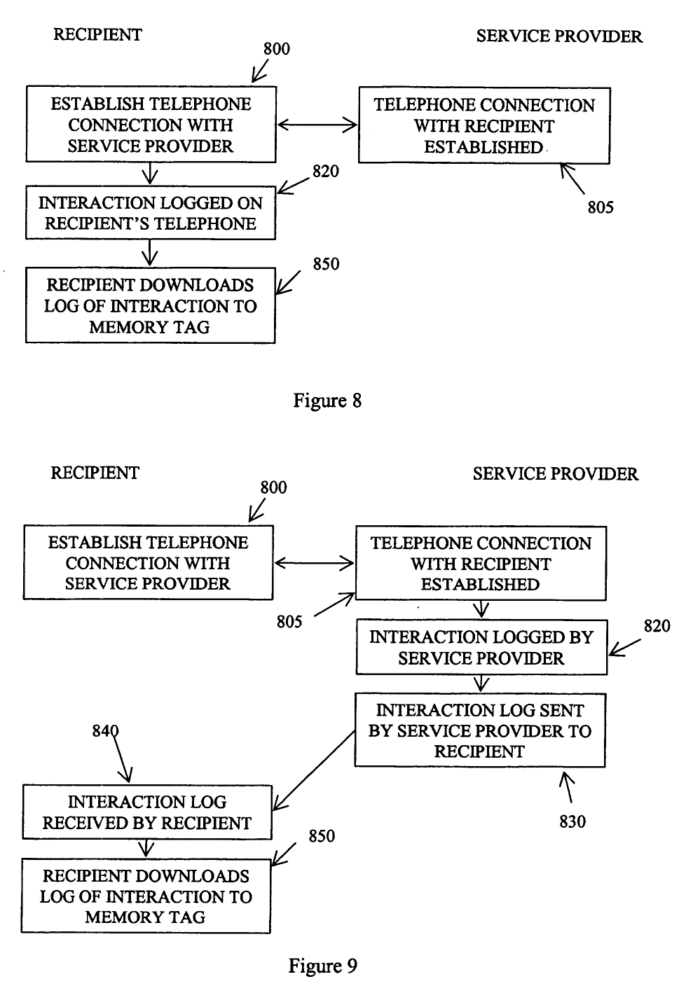

Both the FIG. 6 and FIG. 7 arrangements require only the reading of data from the memory tag, and not writing to it. The memory tag may therefore contain read-only memory (or memory which is read-only to a memory tag reader). Other possibilities become available if the memory tag can be written to as well as read from. One such possibility is that the document can be used as a repository for information relating to the interaction between the recipient and the customer representative. This can apply in either the FIG. 6 or FIG. 7 cases, but also if the memory tag contains neither routing information nor an identifier but only a telephone number for the service provider (or even if the memory tag contains no information at all initially). Steps involved in two alternative ways to implement this process are shown in FIGS. 8 and 9 respectively.

In the approach shown in FIG. 8, transaction logging takes place at the recipient's telephone. This may be done effectively by recording of the conversation between the recipient and the customer representative. Once a telephone connection is established (800, 805) between the document recipient and the service provider, the recipient starts to log the interaction (820) on the cellular telephone. The simplest way to do this is by simply recording the interaction (as speech), though other approaches (such as transcription) are possible. The transaction log is then downloaded (850) by the user from the cellular telephone with the reader to the memory tag on the document, so the document is available as a record of the conversation for future reference. Several such interactions may be downloaded to the document memory tag—this may require the memory tag to have at least a minimal file structure (for example, with an index indicating the order and perhaps details such as time and length of recording for each item, with specific log items being made available when selected from the index).

In the alternative approach shown in FIG. 9, transaction logging takes place at the service provider and is then communicated to the recipient. Once a telephone connection is established (800, 805) between the document recipient and the service provider, the service provider begins to log (820) the interaction. This may be by recording, or by providing an indication of any changes or updates made to the recipient's customer record on the service provider's CRM system. The latter approach may be preferable, as this will generally lead to a log of a smaller size which will be easier to transmit (830) back to the recipient—a sufficiently small log may be transmitted, for example, in the form of an SMS message, whereas a larger log may need to be transmitted as a download or e-mail attachment. The log received (840) by the cellular telephone of the recipient can then be downloaded (850) to the memory tag as in the FIG. 8 case.

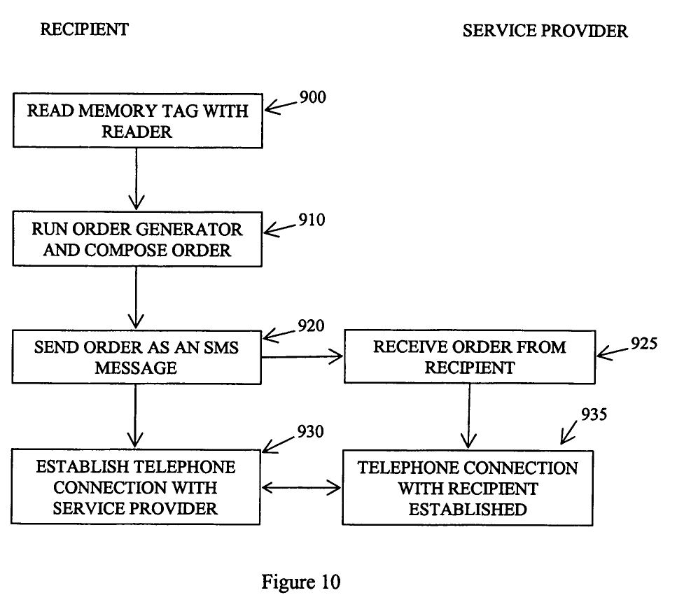

In some forms of transaction, it may be desirable for information to be provided in written form by the recipient. Transactions using pro forma order forms provided in a memory tag are discussed in the applicant's copending application of even date entitled “Ordering of Goods and Services using Digital Pro Forma”. In FIG. 10 there is discussed a variation of the embodiments discussed above, in which a pro forma information provision form (which may be an order form, or merely a way to provide additional customer information) is stored on the memory tag. This is provided in the form of code for execution on the user's cellular telephone. This code may be used, for example, to compose an SMS message to the service provider. This may be sent, and followed with a telephone call as discussed in any of the FIG. 6 to FIG. 9 embodiments.

The memory tag is first of all read (900) as in the earlier examples. The information in the memory tag is provided in the form of executable code. This executable code is executed by the recipient (910) on his cellular telephone (or, as discussed below, on another computing device with communications capability). The first step in executing the code is providing data required for interaction with the service provider—typically personal details of the recipient or specification of the service that they require (for example, answers to a list of questions relating to an insurance application—the answers may be “yes”, “no” or “discuss”, with “discuss” answers requiring discussion with a customer representative). From the recipient's answers, a message may be composed—desirably an SMS (because of the ease and low communications latency in transmission of SMS messages) where possible but alternatively an e-mail. Where information is sensitive, it may be encrypted rather than provided in clear—for example, it could be encrypted with a key also stored on the memory tag and provided by running the application. The message—generally an order for a service, but possibly, say, a request for more relevant information based on the specific details of the recipient (such as a quotation)—is then sent (920) to the service provider who receives (925) this information and processes it accordingly. Telephonic communication is then established between recipient and service provider as for the previous examples (930, 935). It is now possible for the further information to be provided, or the order finalised, very efficiently by the recipient and the customer representative. Efficiency is achieved as this approach reduces still further time spent by the customer representative on the specific transaction (as the details provided by message are already present on the service provider system) and obviates the need for a checking step (as the recipient has provided data electronically and has had an opportunity to check it—there is now no possibility of introducing a transcription error by the service provider).

The embodiments above discuss the use of a cellular telephone of the recipient for communication with the service provider. The skilled person will appreciate that in place of a cellular telephone, any communications device with appropriate computing capability—or combination of computing device and communications device interacting together—may be employed. Embodiments of the invention may therefore employ any of a desktop PC, a laptop PCs, and a PDA, for example. The communications device may use the wired telephony infrastructure rather than a cellular telephony infrastructure.

1. A document having printed information and a memory tag thereon, wherein the memory tag is a transponder device with a memory for storing digital content, the memory containing therein information relating to the progression of a transaction between a customer and a service provider.

2. A document as claimed in claim 1, wherein the memory contains a telephone number for the service provider.

3. A document as claimed in claim 2, wherein the memory contains routing information to route a telephone call through the automatic call distribution system of the service provider to a customer representative notified of the subject matter of the printed information.

4. A document as claimed in claim 1, wherein the document is a letter addressed to a recipient.

5. A document as claimed in claim 4, wherein the memory contains an identifier representing the recipient on a customer relations management system of the service provider.

6. A document as claimed in claim 1, wherein the memory contains details of at least one interaction between a user of the document and the service provider.

7. A document as claimed in claim 1, wherein the memory contains a pro forma order for completion by a recipient and return to the service provider.

8. A method of interacting with a service provider, comprising:
uploading information from a memory tag on a document to a communications device;
establishing telephonic communication with a service provider; and
using the uploaded information to facilitate an interaction with the service provider.

9. A method as claimed in claim 8, wherein the step of facilitating a transaction comprises providing routing information to enable correct routing through an automatic call distribution system of the service provider.

10. A method as claimed in claim 8, wherein the step of facilitating a transaction comprises providing an identifier for recognition by the customer relations management system of the service provider.

11. A method as claimed in claim 8, wherein the step of facilitating a transaction comprises completing a pro forma order and sending it to the service provider by a messaging protocol.

12. A method of interacting with a customer, comprising:
printing a mail message for transmission by a mail service;
providing with the printed mail message a memory tag, wherein the memory tag is a transponder device with a memory for storing digital content, and storing within the memory therein information relating to the progression of a transaction between a customer and a service provider.

13. A method as claimed in claim 12, wherein the information contains a telephone number for the service provider.

14. A method as claimed in claim 12, wherein the memory contains routing information to route a telephone call through the automatic call distribution system of the service provider to a customer representative notified of the subject matter of the printed information.

15. A method as claimed in claim 12, wherein the memory contains an identifier representing the recipient on a customer relations management system of the service provider.

16. A method as claimed in claim 12, wherein the memory contains a pro forma order for completion by a recipient and return to the service provider.
